(19) United States
(12) Patent Application Publication
(10) Pub. No.: US 2012/0175385 A1
(43) Pub. Date: Jul. 12, 2012

(54) Valve Assembly for a Dispenser for Fluids

(75) Inventor: Marcus Johannes Voskuil, GT Oegstgeest (NL)

(73) Assignee: Fluid Management Operations, LLC, Wheeling, IL (US)

(21) Appl. No.: 12/986,273

(22) Filed: Jan. 7, 2011

(51) Int. Cl. B67D 7/78; F16K 1/00; B67D 7/58; B67D 7/06

(52) U.S. Cl. 222/144; 251/321; 222/144.5; 222/380

(57) ABSTRACT

A valve assembly for a dispenser for fluids includes a housing having at least an inlet opening and an outlet opening and a further opening connected or connectable to a fluid displacement mechanism, and a valve member comprising two parts translatably disposed within the housing, a first part for closing and opening the inlet and a second part for opening and closing the outlet.

### BACKGROUND

1. Technical Field

This disclosure relates to a valve assembly for a dispenser for fluids comprising a housing having at least an inlet opening and an outlet opening and a further opening connected or connectable to a fluid displacement mechanism, e.g. a piston pump, and a valve member disposed within the housing. This disclosure also relates to an apparatus for dispensing fluids comprising a plurality of such valve assemblies.

2. Background of the Related Art

EP 1 688 652 relates to a valve assembly comprising a housing and a valve member mounted within the housing rotatable about an axis and between at least a dispensing position and a further position, for instance a volume selection position during which a material can be withdrawn from a container, and, preferably, a seat for mounting and guiding the valve member within the housing, wherein at least one of said housing, valve member, and seat is made of a synthetic material and the assembly further comprises a spring, which urges at least two of said housing, valve member, and seat together.

WO 02/14726 discloses a valve assembly comprising a “valve enclosure body 10 having at least a first and a second outlet 11, 12 for liquid flowing through the valve. The valve construction . . . is intended especially for use in liquid dispensing devices, in which case the first outlet 11 . . . leads to a liquid container through a suction pipe, for instance, and the second outlet 12 is connected to liquid dispensing through a nozzle pipe, for instance. The vertical outlet in the figure connects to a plunger pump in the dispensing device . . . . A valve element 13 is located in the valve enclosure 10 and moves between two extreme positions. In one extreme position, the valve element 13 closes the first outlet 11 and in the second extreme position, it closes the second outlet 12.”

This disclosure provides a valve assembly for dispensing fluids that allows more cost effective manufacture, in particular by inherently allowing wider tolerances.

### SUMMARY OF THE DISCLOSURE

To this end, the disclosed valve member comprises two parts translatably disposed within the housing, a first part for closing and opening the inlet and a second part for opening and closing the outlet.

In an aspect, the parts are resiliently biased apart and into closing abutment with the inlet and outlet openings, e.g. by means of an elastic element, such as a spring, positioned between the first and second parts of the valve member. In another aspect, a resilient seat is provided at the interface between at least one of the parts and the opening it closes.

Using two translating parts enables a relatively straightforward design and avoidance of a so-called tolerance stack, e.g. by including one or more resilient elements between the parts or between one or both of the parts and the inlet and outlet openings. Also, if the valve parts and housing are made of a polymer, the resilient elements, in particular the spring between the valve parts, will compensate for creep.

In an aspect, the valve assembly comprises an operating element extending through the wall of the housing and coupled to the first and second parts of the valve member. In a further aspect, the operating element provides at least three positions, a first position wherein both parts are in closing abutment with respective openings, a second position wherein the first part of the valve member is withdrawn from the inlet and the second parts closes the outlet, and a third position wherein the second part of the valve member is withdrawn from the outlet and the first part closes the inlet.

In a further aspect, the parts and/or the inner wall of the housing are provided with guides, such as fins or ribs extending in axial direction, supporting translating motion of the parts and defining openings or channels that allow the fluid to flow from the inlet to the displacement mechanism and from the displacement mechanism to the outlet.

This disclosure further relates to an apparatus for dispensing a plurality of fluids, comprising a support, such as a turntable or a linear table, a plurality of containers for holding a fluid and mounted on the support, and pumps and valve assemblies as described above connected to respective containers.

In an aspect, at least some, preferably all, of the pumps are located below the container and/or extend at least substantially horizontally. The valve assemblies provide a reliable seal between the container and the pump and a reduced risk of leaking due to hydrostatic pressure in the container, thus allowing the specified location which in turn facilitates operating the valves and pumps by means of an internal central actuator.

Within the framework of this disclosure, the term “fluid” is defined as any material that can flow and that can be dispensed by the apparatus according to this disclosure. Examples of fluids include liquids, pastes, granulates, and powders.

### BRIEF DESCRIPTION OF THE DRAWINGS

FIG. 1 is a perspective view of an apparatus for dispensing fluids according to this disclosure in conjunction with an external computer system.

FIGS. 2A and 2B are perspective views of sub-assemblies of a container, a valve, and a pump as used in the apparatus shown in FIG. 1.

FIGS. 3A to 3C are cross-sections and a side view of a valve and pump according to this disclosure, with the valve closed.

FIGS. 4A and 4B are cross-sections of the valve in its intake position.

FIGS. 5A and 5B are cross-sections of the valve in its dispense position.

FIGS. 6A to 6C are cross-sections of a further example of a valve and pump according to this disclosure.

The drawings are not necessarily to scale and details, which are not necessary for understanding this disclosure, may have been omitted. Terms such as “upward”, “downward”, “upper” and “lower” merely refer to the orientations shown in the drawings.

### DETAILED DESCRIPTION OF THE PRESENTLY PREFERRED EMBODIMENTS

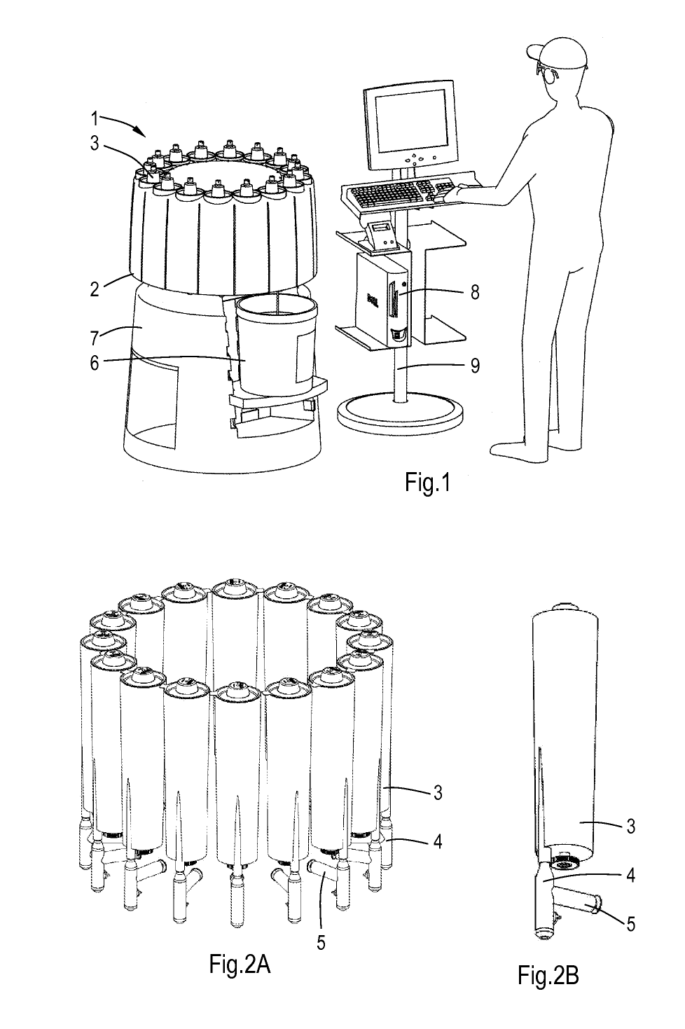

FIGS. 1, 2A, and 2B show an example of an apparatus 1 for dispensing a plurality of fluids, such as (components of) paints, paint colorants, hair dyes, shampoos, foundations, and the like. It can be used for dispensing numerous recipes and formulas of the said products and can be located e.g. at a retailer of decorative paints, a hairdresser, or a spa, respectively.

This particular dispensing apparatus 1 is an automated version and includes a horizontal turntable 2, with a plurality of containers 3 mounted along its circumference (FIG. 2A). Each container 3 is provided with a dispense valve assembly 4 and pump 5 (FIGS. 2A and 2B). The turntable 2 can be rotated between discrete positions, e.g. twelve or sixteen positions including a dispensing position, i.e. the position where the valves 4 and pumps 5 are operated by means of a central actuator and fluids are dispensed in a receptacle, in this example a bucket 6.

The apparatus 1 includes a base 7 made of e.g. a polymer and by injection moulding. A computer 8 for entering and storing information, such as customer data and recipes, and generating instructions for driving the turntable 2, valves 4 and pumps 5 is positioned on a separate stand 9.

Further details regarding suitable turntables and procedures for driving the various components, are disclosed in, for instance, international application WO 03/083334, European patent application 0 992 450, and European patent application 0 800 858.

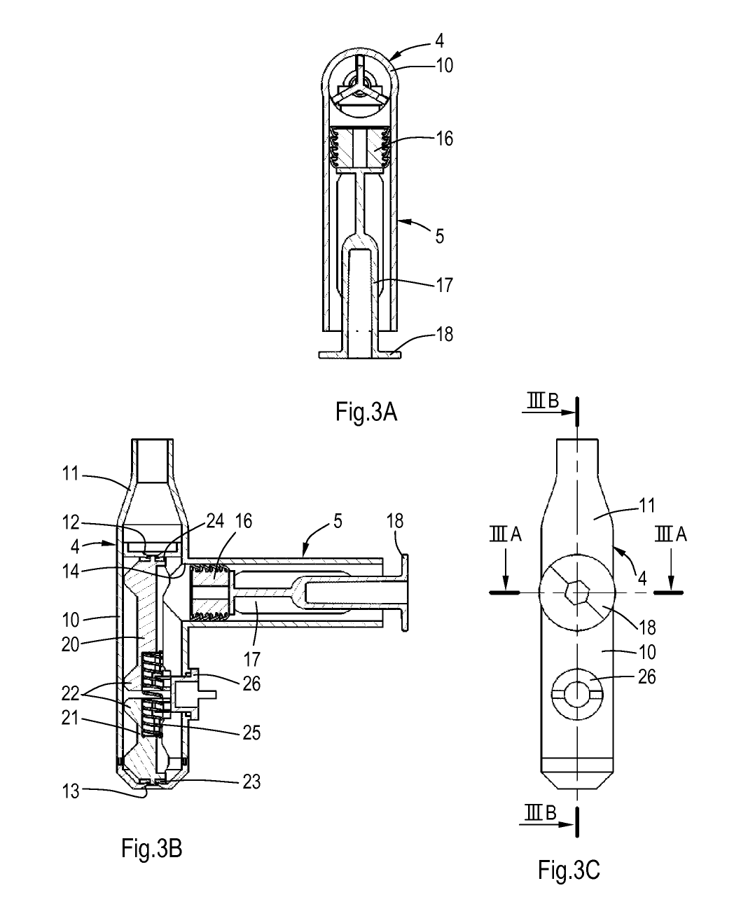

As shown in FIGS. 3A to 3C, each valve assembly 4 comprises a housing 10 having a cylindrical or conical top section 11 with which the valve assembly 4 can be fitted in an outlet opening in or near the bottom of a container 3. The housing 10 further has an inlet opening 12 in or near its top section 11, an outlet opening 13 in or near its bottom, and a further opening 14 in is side wall, which opening 14 communicates with a pump 5. In this example, the pump 5 comprises a cylinder 15 forming an integral part of the housing 10 and a piston 16 and piston rod 17 mounted inside the cylinder 15. The piston rod 17 is provided, on its end remote from the piston 16, with a washer or flange 18.

A valve member is translatably disposed within the housing 10. The valve member comprises two parts, a first part 20 for closing and opening the inlet 12 and a second part 21 for opening and closing the outlet 13. The housing 10 is cylindrical and the valve parts 20, 21 have a star-shaped cross-section (FIG. 3A) that, on the one hand, provides guides 22 that support translating motion of the valve parts 20, 21 within the housing 10 and prevent the valve parts 20, 21 from tilting and that, on the other hand, define channels to allow the fluid to flow from the inlet 12 to the pump 5 (along the upper valve part) and from the pump 5 to the outlet 13 (along the lower valve part). To reduce friction of the valve parts 20, 21 within the housing 10, each part abuts the inner wall of the housing on just two axial levels.

Each of the parts 20, 21 is provided, at its end facing the respective opening 12, 13, with a resilient seat 23, 24, made of e.g. silicone or a (fluoro) elastomer such as Viton™. Further, the valve parts 20, 21 are resiliently biased apart and into closing abutment with the inlet and outlet openings 12, 13 by means of a helical spring 25 positioned between the first and second parts 20, 21 of the valve member. A helical spring provides suitable stiffness and stroke as well as an open structure that adds little of no resistance to the flow of fluid within the housing.

Finally, the valve assembly comprises an operating element, e.g. a handle, lever, or, in this example, a rotary knob 26 extending through the wall of the housing 10 and coupled to the first and second parts 20, 21 of the valve member.

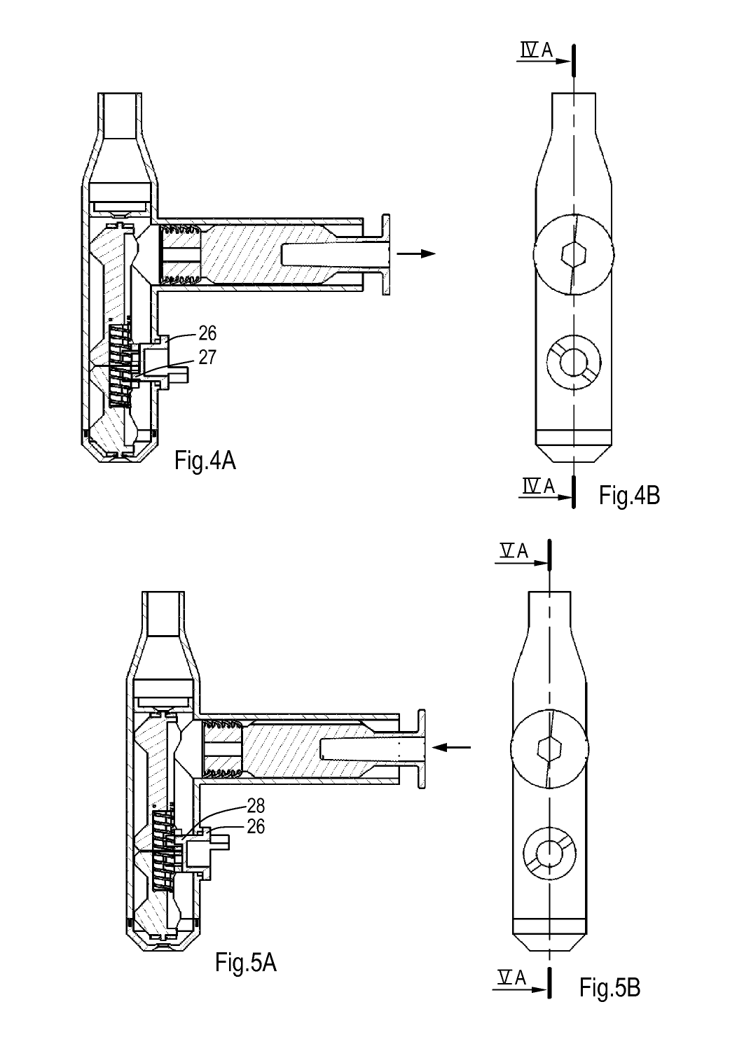

The rotary knob 26 provides three positions, a first or closed position wherein both the inlet opening and the outlet opening are closed by the valve parts (FIGS. 3A to 3C), a second or intake position wherein the first part of the valve member is withdrawn from the inlet and the second part closes the outlet (FIGS. 4A and 4B) and a third or dispense position wherein the second part of the valve member is withdrawn from the outlet and the first part closes the inlet (FIGS. 5A and 5B).

Further, in this example, the rotary knob 26 comprises, on its distal face two eccentric protrusions 27, 28 that cooperate with straight slots on the valve parts 20, 21. The slots extend in a direction perpendicular to the direction of translation of the valve parts and have a width that exceeds the diameter of the eccentric protrusions. If the rotary knob 26 is rotated clockwise the upper protrusion 28 pulls the upper valve part downwards and the lower protrusion 27 clears the lower valve part. If the rotary knob 26 is rotated counter-clockwise the lower protrusion 28 pulls the lower valve part upwards and the upper protrusion 27 clears the upper valve part.

In the intake position of the knob and the valve parts, the pump communicates with a container and is filled with a desired amount of the fluid from the container by pulling the flange 18 and thus the piston 16 away from the valve over a desired or predetermined length by means of a central actuator. As soon as a selected amount of fluid has been taken in, the knob is rotated, via the closed position, to the dispense position. In this position, the pump communicates with the dispense outlet in the bottom surface of the pump housing and the fluid is dispensed by pushing the flange and thus the piston towards the valve.

In the configuration described above, the direction of translation of the first and second valve parts and the direction of the resilient bias are aligned and are normal (i.e., perpendicular) to the area defined by the inlet and outlet openings. The spring and the resilient seats compensate variations in the dimension of the housing and the valve parts and thus inherently allow relatively wide tolerances, i.e. no high precision parts are required, and provide improved reliability.

As a matter of course, this disclosure is not restricted to the above-disclosed embodiments, which may be varied in different manners within the spirit and scope of this disclosure. For example, although it is preferred that the first and second valve parts are separate (detached) parts, the parts could instead be telescopically coupled or indeed resiliently attached.

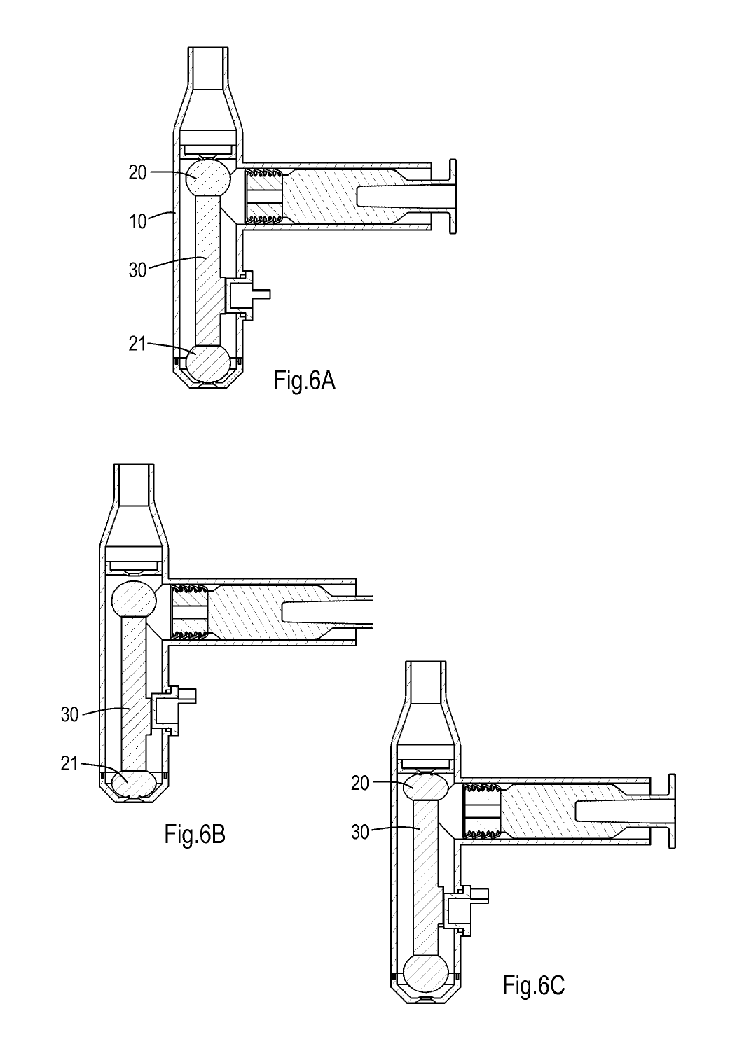

In the embodiment shown in FIGS. 6A to 6C, the first and second valve parts 20, 21 are made of a resilient material, e.g. an elastomer, such as Viton™. A rigid element, e.g. a rod 30 made of a non-elastomeric polymer, such as PET or PEEK, or of a metal, such as aluminum, is positioned between the parts 20, 21. In this example, the valve parts are attached to the rod yielding an overall length that exceeds the length of the cavity defined by the housing. Thus, in the closed position, both the inlet and the outlet openings are closed and the valve parts are resiliently compressed (deformed; FIG. 6A). In the intake position, the valve member is forced in the direction of the outlet opening, clearing the inlet opening and further compressing the lower valve part (FIG. 6B). In the dispense position, the valve member is forced in the direction of the inlet opening, clearing the outlet opening and further compressing the upper valve part (FIG. 6C).

In a further variation, instead of operating both valve parts with a single operating element, each part could instead be individually provided with an operating element.

What is claimed is:

1. A valve assembly for a dispenser for fluids comprising:
a housing having at least an inlet opening and an outlet opening and a further opening connected or connectable to a fluid displacement mechanism, and
a valve member comprising two parts translatably disposed within the housing, a first part for closing and opening the inlet and a second part for opening and closing the outlet.

2. The valve assembly according to claim 1, wherein, in at least one position of the valve, the parts are resiliently biased or urged into closing abutment with the inlet and outlet openings.

3. The valve assembly according to claim 2, comprising an elastic element positioned between the first and second parts of the valve member.

4. The valve assembly according to claim 3, wherein the elastic element is a helical spring.

5. The valve assembly according to claim 1, wherein a resilient seat is provided at the interface between at least one of the parts and the opening it closes.

6. The valve assembly according to claim 1, wherein the first and second parts are resilient and a rigid element is positioned between the parts.

7. The valve assembly according claim 6, wherein the overall length of the valve parts and the rigid element exceeds the length of the cavity defined by the housing.

8. The valve assembly according to claim 1, comprising an operating element extending through the wall of the housing and coupled to the valve member.

9. The assembly according to claim 8, wherein the operating element provides at least three positions, a first position wherein both parts are in closing abutment with respective openings, a second position wherein the first part of the valve member is withdrawn from the inlet and the second part closes the outlet, and a third position wherein the second part of the valve member is withdrawn from the outlet and the first part closes the inlet.

10. The valve assembly according to claim 1, wherein at least one of the parts and/or the inner wall of the housing is provided with guides supporting translating motion of the parts and defining openings or channels that allow the fluid to flow from the inlet to the displacement mechanism and from the displacement mechanism to the outlet.

11. The valve assembly according to claim 1, wherein the direction of translation of the first and second parts and of the resilient bias are parallel or aligned and at least substantially normal to the area defined by the inlet and outlet openings.

12. The valve assembly according to claim 1, wherein the housing is connected to a piston pump.

13. An apparatus for dispensing a plurality of fluids, comprising a support, such as a turntable or a linear table, a plurality of containers for holding a fluid and mounted on the support, pumps and valve assemblies according to claim 1 connected to respective containers.

14. The apparatus according to claim 13, wherein the pumps form an integral part of the valve assemblies.

15. The apparatus according to claim 13, wherein at least some of the pumps are located below the container and/or extend at least substantially horizontally.
